(19) United States
(12) Patent Application Publication
(10) Pub. No.: US 2014/0266781 A1
(43) Pub. Date: Sep. 18, 2014

(54) DISTRIBUTED WIRELESS NETWORK FOR CONTROL SYSTEMS

(71) Applicant: COOL EARTH SOLAR INC., Livermore, CA (US)

(72) Inventor: Kurt Ottaway, Pleasanton, CA (US)

(73) Assignee: COOL EARTH SOLAR INC., Livermore, CA (US)

(21) Appl. No.: 14/205,099

(22) Filed: Mar. 11, 2014

Related U.S. Application Data
(60) Provisional application No. 61/778,306, filed on Mar. 12, 2013.

(51) Int. Cl. G01D 4/00

(52) U.S. Cl. CPC G01D 4/002
USPC 340/870.02

(57) ABSTRACT

A wireless distributed network for transmitting data from an array of solar energy collectors to a control and monitoring system. Each solar energy collector in the array has a local control unit that can collect telemetry and other operational data for the solar energy collector. The data is periodically transmitted to ‘churped’ by the local control unit without the wireless manager querying the local control unit for sending the data. The data is routed via the distributed wireless network that links all the solar energy collectors in the array with the control and monitoring system. Multiple data paths are possible, which increases the redundancy and robustness of the wiereless network.

### CROSS-REFERENCE TO RELATED APPLICATION

This is a non-provisional U.S. Provisional Application No. 61/778,306, filed Mar. 12, 2013, and is hereby incorporated by reference herein in its entirety for all purposes.

### BACKGROUND

Control systems conventinally monitored using wired connections since wireless connections are considered unreliable as a typical control system needs real-time monitoring and control. Since wireless networks are inhernetly unreliable, they are usually not used in mangaign a control system.

There is a need in the indsutry to develop reobust and reliable wireless networks that can be used to monitor and operate control systems, both in a real-time enviroment and non-realtime environment.

### SUMMARY

Embodiments of the presnet invention provide a wireless network in which plurality of nodes in are in communication with each other and/or with a centralized wireless manager. Each node in the wireless network is connected to and can communicate with at least one other node in the network. In some embodiments, each node in the wireless network can be connected to and can communicate with multiple other nodes and ultimately to the centralized wireless manager. The wireless network exhibits a decentralized character as each node can collect data, execute algorithms, and issue commands. In some embodiments, the nodes are configured to periodically transmit data upstream to the wireless manager at relatively long time intervals ranging from about every 0.5 seconds to about every 20 seconds.

In some embodiments, a particular node may not be directly connected to the wireless manager. In this instance, the node may still send captured data to the wireless manager by routing its data via one or more other nodes in the wireless network. This results in more reliable, fault-tolerant network communication. In the instance where any particular node is disabled or otherwise unavailable, the wireless network can find alternate paths to route the data from a node to the wireless manager.

In some embodiments, the wireless network may employ frequency hopping technique to communicate data between. Some embodiments of the present invention may be particularly suited to implement supervisory control and data acquisition (SCADA) from a plurality of intelligent sensory nodes distributed over a wide geographic area. In some embodiments, a solar energy harvesting apparatus may represent a node. Several such solar energy harvesting apparatuses' may be linked together wirelessly using techniques described herein to enable centralized monitoring and control of such apparatuses'.

These and other embodiments of the present invention, as well as its features and some potential advantages are described in more detail in conjunction with the text below and attached figures.

### BRIEF DESCRIPTION OF THE DRAWINGS

FIGS. 1 & 1A illustrate a solar energy harvesting appratus according to an embodiment of the present invention.

FIG. 2 illustrates a schematic of an array of solar energy collecting/harvesting apparatuses' connected to a central control system according to an embodiment of the present invention.

FIG. 3 illustrates an exemplary solar energy collector mounted on a tracking and positioning system.

FIG. 4 is a schematic of a distributed wireless network according to an embodiment of the present invention.

FIG. 5 is schematic of a high-level block diagram of a control system unit that may be incorporated into each solar energy collector in the array of FIG. 2, according to an embodiment of the present invention.

FIG. 6 illustrates a distributed wireless network connected to a Supervisory Control and Data Acquisition (SCADA) server via a wireless manager according to an embodiment of the present invention.

FIG. 7 is a flow diagram of a method for operating a distributed wireless network according to an embodiment of the present invention.

### DETAILED DESCRIPTION

Solar radiation is a relatively easy form of energy to manipulate and concentrate. It can be refracted, diffracted, or reflected, to achieve concentrations of up to thousands of times the initial flux, utilizing only modest materials. Conventionally, however, the costs associated with a solar energy collector system has proven prohibitive for competing with unsubsidized with fossil fuels, in part because of excessive material costs and large areas that conventional solar collectors occupy. These excessive materials costs and the large areas that are occupied by solar energy collector systems may render them unsuitable for large-scale solar power generation projects.

In one instance the tendency of a thin, flat film to assume a consistent tubular shape when rolled and inflated may be used to create an inexpensive solar energy collector. Specifically in a particular embodiment, small prisms may be formed in a clear film to create a desired focus or foci when the film is inflated in a tubular configuration.

In another instance, the tendency of a flat reflective film to assume a smooth concave shape under the influence of a pressure differential may be used to fabricate a solar energy collector. Specifically, in a particular embodiment, inflation air may be used to impart a curved profile to a reflective component for a solar collector structure.

Such inflatable solar energy collectors may offer certain benefits over conventional designs that employ more common structural elements. For example, an inflatable energy collector uses air as a structural member, and may employ thin plastic membranes (herein referred to as films) as a primary optic. This can yield significant weight advantages in a system deployed in the field. The weight advantages in the concentrator itself can in turn reduce the amount and complexity of the structures of the mounting and tracking systems used with the solar energy collector. This will help to reduce the overall mass and cost of the solar collector system.

According to certain embodiments, a solar collector may utilize an inflated refractive concentrator having a tube-like shape and including refractive prism elements in order to achieve one or more focus areas of concentrated refracted light on a receiver. The collector may be assembled from inexpensive, lightweight, and readily-available materials such as polymer films. As described below, depending upon the particular embodiment, a thermal or concentrated photovoltaic (CPV) receiver may be disposed within, outside of, or at a surface of, the inflated concentrator.

According to certain other embodiments, a solar collector may utilize an inflated reflecting concentrator having a tube-like shape in order to achieve focus of concentrated reflected light along a line on a receiver. The collector may be assembled from inexpensive, lightweight, and readily-available materials such as aluminized polymer film (exhibiting reflecting properties) and polyester film (exhibiting optically transparent properties). As described below, depending upon the particular embodiment, a thermal or concentrated photovoltaic (CPV) receiver may be disposed within, outside of, or at a surface of, the inflated concentrator. In addition as described herein (for example in connection with FIGS. 7-8), by virtue of its operation to gather and focus light in one dimension, single-axis tracking of such a trough-type collector may be sufficient.

Certain embodiments may seek to reduce the levelized cost of energy of a solar power plant, and to maximize the scale at which such plants can be deployed. Embodiments of solar collector devices and methods may be utilized in conjunction with power plants having one or more of the attributes described in that patent application.

The objectives of reduced levelized cost and maximized scale of a solar power plant, can be achieved through the use of elements employing minimal materials and low-cost materials that are able to be mass produced. Potentially desirable attributes of various elements of such a solar power plant, include simple, rapid, and accurate installation and assembly, ease of maintenance, robustness, favorable performance at and/or below certain environmental conditions such as a design wind speed, and survivability at and below a higher maximum wind speed.

In particular embodiments, inflation air may be used to impart a concave profile to a reflective component of a concentrator for a solar collector structure. Specifically, a reflective surface in the form a metalized film shaped by inflation pressure, may be used to create an elongated inflated tubular concentrator defining a reflective trough for communicating concentrated solar energy to a receiver, such as a thermal or photovoltaic receiver.

FIGS. 1 and 1A show simplified perspective and cross-sectional views, respectively, of one embodiment of an inflated energy collector/harvesting device according to an embodiment of the present invention. Solar energy collector 100 comprises a clear film 102 joined to a reflective film 104 (here Aluminized) by a film seal 106. According to certain embodiments, the films may be directly sealed to each other. According to other embodiments, the film seal can be formed by having the films attached to separate sealing member(s).

In certain embodiments, the films may define a tubular shape in which the cross-section of the concave reflective film is half-circular. The inclusion of circular end pieces 108, may define an internal inflation space 110 having a substantially circular profile. Alternately, in certain embodiments end(s) of the films may be self-sealed, pinched like a sausage, or sealed together in the same plane as the other linear edge seals. Such approaches may allow for lower cost manufacturing. While some light from the ends may be lost, or the “spot” may not extend all the way along the tube, the resulting cost benefit could be favorable.

In certain embodiments clear film 102 may comprise a polymer. Many different types of polymers are candidates for clear film 102. One form of polymer which may be suitable is polyester, examples of which includes but is not limited to polyethylene terephthalate (PET) and similar or derivative polyesters such as polyethylene napthalate (PEN), or polyesters made from isophthalic acid, or other diols such as but not limited to butyl, 2,2,4,4 tetramethylcyclobutyl or cyclohexane.

According to certain embodiments clear film 102 may be formed from poly(meth methacrylate) (PMMA) and co-, ter-, tetra-, or other multimonomeric polymers of methacrylates or acrylates including but not limited to monomers of ethyl, propyl and butyl acrylate and methacrylates. Other examples of polymers forming the upper transparent film include but are not limited to polycarbonate (PC), polymethylpentane (TPX), cyclic olefin derived polymers such as Cyclic olefin co-polymers (COC), cyclic olefin polymer (COP), ionomer, fluorinated polymers such as polyvinilidene fluoride and difluoride (PVF and PVDF), ethylene tetrafluoroethylene (ETFE), ethylene chlorotrifluoroethylene (ECTFE), fluorinated ethylene propylene (FEP), THV and derivatives of fluorinated polymers, and co-extruded, coated, adhered, or laminated species of the above. Examples of thicknesses of layers of such materials may include from about 0.012 mm to 20 mm, depending on the strength of the material and the size of the collector. In some embodiments, film 102 may comprise two or more layers. Each layer can be chosen from any of the materials listed above.

Incident optical energy 111 may pass through the clear film 102, and be reflected by reflective film 104 to concentrate light along an elongated focus region 112. Provision of a receiver in this elongated focus region, may allow conversion of the reflected solar energy into other forms of energy (including but not limited to thermal energy or electrical energy).

In some embodiments, a full half circle cross section for a reflector (half-cylinder) reflects only a portion of the incident rays 111 back in a direction where they can be captured by a receiver. Another portion of the incident rays 111 may reflect in a direction such that they bounce off the reflective surface again, from a different location, sometimes multiple times, without converging at a feasible receiver location 112.

It is to be noted that the solar energy collector illustrated in FIGS. 1 and 1A are exemplary and embodiments of the invention are not limited to such type of solar energy collectors. Techniques disclosed herein can be used with any other type of solar energy collector such a solar panels, etc.

When used in solar power plant configuration, several such solar energy collectors can be deployed over a vast geographical area. For instance, several hundred or thousands of such solar energy collectors can be installed at a location that has unobstructed view of the Sun in order to get the maximum exposure to the Sun. FIG. 2 is a schematic that illustrates several solar energy collectors 202 (e.g., solar energy collector 102 of FIG. 1) arranged in a rectangular array and connected together to generate electrical and/or thermal energy according to an embodiment of the present invention. It is to be noted that FIG. 2 is exemplary and the solar energy collectors can be arranged in any manner that is feasible based on the size and shape of the solar energy collector and the land that they are installed on. Each solar energy collector 202 can have an on-board control system unit 204 that controls the operation of each solar energy collector 202. The control system unit 204 may include sub-systems that can move and orient the solar energy collector in manner so as to gather maximum sunlight throughout the day as the Sun changes its position in the sky. The control system may include various sensors that gather telemetry data including but not limited to air pressure, temperature, position of the Sun, flow rates, current operating status of the solar energy collector, etc. Although only one solar energy collector 202 in FIG. 2 is shown as having control system 204, it is to be understood that each solar energy collector may include such a control system unit. All the solar energy collectors 202 may be connected either directly or indirectly to a control and monitoring system 206.

FIG. 3 illustrates an exemplary solar energy collector mounted on a tracking and positioning system. Four inflated film tubular solar concentrators 304 are configured to track the sun in elevation and azimuth. Concentrators 304 are mounted to an upper structure 306 which pivots on rollers 320 about a virtual elevation axis 308 with respect to a lower structure 310. Lower structure 310 is rotatably connected to the ground via ground anchor 312. Ground anchor 312 defines an azimuth axis 314. System 302 rotates with respect to the ground about azimuth axis 314 and is driven by a drive wheel 316. A follower wheel 318 provides additional ground support for system 302. Together, ground anchor 312 and the two wheels 316 and 318 create 3 points of ground contact at or near the maximum spatial extents of the system for greatest system stiffness and stability. Azimuth actuation through wheel 318 happens at or near the largest distance from azimuth axis 314 which reduces the actuation forces required, increases stiffness and reduces the cost and complexity of actuator transmission components by allowing less gear reduction for a given amount of torque to be applied to system 302. Similarly, an elevation actuator 322 acts to apply actuation torque to upper structure 306 at or near the largest possible distance from elevation axis 308 in order to reduce forces and elevation actuator transmission cost and complexity. Wheels 316 and 318 are configured to operate directly on unprepared ground or soil which reduces system costs and installation costs. System 302 is able to track the sun's position despite ground irregularities, bumps, holes or obstacles. As wheels 316 and 318 travel to create azimuth motion and pass over an obstacle. Elevation actuator 322 can adjust the position of upper structure 306 so that a desired elevation orientation is maintained despite the ground irregularities.

It is to be noted that the tracking and positioning mechanism illustrated in FIG. 3 is exemplary. One skilled in the art will realize that there are other types of tracking a positioning mechanisms that can be used based on the architecture of the solar energy collector apparatus. The following US patents, US Patent Applications, and US Patent Application Publications described various types of solar energy collectors and associated control systems. The content of each of the following applications and publications is incorporated by reference herein in their entirety for all purposes. All of these applications are co-owned by the assignee of this application.

1) U.S. Patent Application Publication No. 2011/0180057

2) U.S. Patent Application Publication No. 2010/0295383

3) U.S. patent application Ser. No. 13/338,607

4) US Patent Application Publication No. 2010/0224232

5) U.S. Pat. No. 7,866,035

6) US Patent Application Publication No. 2008/0047546

7) US Patent Application Publication No. 2008/0057776

8) U.S. patent application Ser. No. 13/227,093

9) US Patent Application Publication No. 2008/0168981

10) US Patent Application Publication No. 2011/0180057

In order to ensure the energy collecting surface of each solar energy collector is always oriented towards the Sun, the solar energy collector has to be moved as the Sun traverses in the sky during the daytime. In a solar power plant, hundreds or thousands of such solar energy collectors may have to be manipulated in this manner to orient them to face the Sun. In such an instance, a central control of these solar energy collectors is desirable. However in order to have effective central control of multiple solar energy collectors data from each solar energy collector has to be received and analyzed in order to maintain proper control of each solar energy collector.

Traditional methods of hardwiring of each solar energy collector to a central control system is not feasible since in many instances the solar energy collectors may be spread over a vast area covering several hundred acres of land. Also, a traditional wireless network with a base station communicating with each solar energy collector is also not feasible since it will involve installing several additional wireless repeater stations throughout the installed area in order to get a reliable wireless connection. It is well-known that a wireless signal degrades as function of distance. When a wireless signal from a solar energy collector that is located several thousand yards from the base station is transmitted via numerous repeaters to the base station, there is high likelihood that the signal may be severely degraded or even lost during the long transmission path to the base station.

One embodiment of the present invention solves this issue by implementing a distributed wireless network 400 illustrated in FIG. 4. Wireless network 400 includes a plurality of nodes 402. Each node 402 can represent a single solar energy collector. Each node 402 includes a processing unit 404 that collects sensor data and transmits that data to a wireless manager unit 406. Each node 402 is can be connected to one or more adjacent nodes 402 creating mesh-type architecture. The lines between two nodes represent a wireless communication path 408 between the nodes. However, these communication paths are not static and can be dynamically created as needed when transmitting a data. In other words, since the communication path is wireless it does not exist at all given times between any two given nodes. A wireless communication path can be established dynamically between two nodes if and when needed. Thus, FIG. 4 represents a snapshot of wireless network 400 at a particular instance of time. A snapshot taken at a different time may show different communication paths between the various nodes. However at any given time, either a direct or an indirect communication path exists between any given node 402 and wireless manager 406. For example, as illustrated in FIG. 4, node 402ₓ has a direct communication path to wireless manager 406 while node 402_{y} has one indirect communication path to wireless manager 406 via other nodes 402ₚ and 402ₓ, among other paths.

The advantage of this architecture is that even if one or more nodes in the array become disabled or are non-operational, a signal from an active node can still reach wireless manager 406 since there are multiple communication paths that can be dynamically generated. Unlike conventional wireless networks, the communication of data is not reliant upon a centralized manager asking/querying each node to respond with specific data. Instead, this embodiment, each wireless network node (i.e. solar energy collector) can be configured to collect sensor data on an ongoing basis, and then transmit selected data at regular time intervals to wireless manager 406.

In order to transmit data from any given node to wireless manager 406, the originating node selects the best possible path, from N possible paths, to route the data. The algorithm for choosing the best possible path can look at several factors such as number of non-operational nodes at the time of transmission of the data, the shortest path between the originating node and the wireless manager, signal strength, frequency disturbance, etc. In some embodiments, instead of choosing a single best path for sending the data, the originating node may send data along multiple different paths for redundancy purposes. In this instance if a node along one of the paths becomes non-operational after the data is sent by the originating node, the data will still reach the wireless manager via one of the other communication paths. This results in more reliable, fault-tolerant network communication. In some embodiments, a commercially available solution such as SmartMesh® wireless sensor network available from Dust Networks™, through Linear Technology Corporation of Milpitas, Calif. may be used.

As described above, each solar energy collector (wireless node) in an array may periodically transmit its data to the wireless manager with the need for querying by the wireless manager. The regular transmission of data may occur over relatively long time intervals. Examples of time intervals between consecutive data transmissions from a node include but are not limited to between about 0.5-20 seconds, between about 1.0-15 seconds, between about 3-10 seconds, between about 4-6 seconds, or about every five seconds. In a particular embodiment, data transmission from each node may occur, every 0.5 seconds, every 1.0 second, every 2 seconds, every 3 seconds, every 4 seconds, every 5 seconds, every 6 seconds, every 7 seconds, every 8 seconds, every 9 seconds, every 10 seconds, every 11 seconds, every 12 seconds, every 13 seconds, every 14 seconds, every 15 seconds, or every 20 seconds.

In some embodiments, communication between two nodes may employ a frequency hopping technique. As is known in the art, wireless signals can be transmitted over various frequencies, e.g., 2.4 GHz and 5 GHz. Sometimes, there may be instances when a certain frequency band becomes temporarily unsuitable for communication, e.g., due to interference from other devices using the same frequency band. In such instances, each node can detect the interference and transmit the data using one of other available frequencies. This is commonly referred to as “frequency hopping.”

FIG. 5 is schematic of a high-level block diagram of a control unit 500 that may be incorporated into each solar energy collector in the array of FIG. 2.

As described above, the control unit 500 is local to each solar energy collector and can control the operation and/or manipulation of the solar energy collectors. It is to be noted that only some of the components of the local control unit 500 are illustrated in FIG. 5. One skilled in the art will realize that there are many more components in the control unit, but are omitted here for brevity.

Microprocessor 502 can be implemented as a single or multiple microprocessors working in conjunction with each other. Microprocessor 502 control the operation of control unit 500 and of the solar energy collector associated with the control unit. A wireless transmitter/receiver 504 can receive and send wireless transmissions on conjunction with the microprocessor. For instance, wherever data is to be transmitted, microprocessor 502 may instruct wireless transmitter/receiver 504 to transmit the data. As is obvious, wireless transmitter/receiver 504 can also receive data transmitted wirelessly by other solar energy collectors. In an embodiment, wireless transmitter/receiver 504 is operable at multiple frequencies. Wireless transmitter/receiver 504 can send data wirelessly to control units of other solar energy collectors in an array or to a wireless manager described throughout this Specification.

Memory 510, which can include ROM and well as RAM type memory can store the data collected by the solar energy collector and well as algorithms/instructions that can be executed by the microprocessors. Memory 510 can be implemented using any know techniques including any of the non-volatile memory devices. Sensors 506 can include various types of sensors including but not limited to pressure sensors, temperature sensors, etc. Sensors 506 collected data and send the data to memory 510 for temporary or long term storage. Input/Output (I/O) interface 508 allows the control unit to communicate with other systems of the solar energy collectors and receive information from these systems (e.g., tracking and positioning system described above).

FIG. 6 illustrates a distributed wireless network 600 connected to a Supervisory Control and Data Acquisition (SCADA) server 602 via a wireless manager 604. Information sent from each of the solar energy collectors 608 is received, stored, and analyzed by SCADA server 602. Based on the received data from each solar energy collector 402, the local control unit of each solar energy collector 402 determines the current operating parameters for each solar energy collector and then determines if any adjustment needs to be made to the solar energy collector. If an adjustment needs to be made, local control system unit 606 of the solar energy collector (e.g., control system unit of FIG. 5) performs the adjustments. The local control system unit manipulates the solar energy collector as needed. The local control system unit is responsible for performing functions such as actuating motors, reading sensors, executing algorithms, issuing commands, and managing telemetry data. In addition, each local control system unit can execute several algorithms in order to collect and process sensor data. Examples of algorithms that may be executed according include, but are not limited to, calculating the ephemeral position of the sun at any given moment in time, managing tracking states, knowing when to enter a safe mode, and executing application program interface (API) commands. Examples of telemetry data that may be managed according to embodiments of the present invention include but are not limited to local_switch_states, alarms, mode_states, target_tracking_position(azi,ele), actual_tracking_position(azi,ele), tracking_control state, air_state, target_air_pressure, actual_air_pressure, cooling_flow_rate, safing_state, etc.

For example, consider that the tracking system on a solar energy collector sends the current location of the Sun in the sky to local control unit 606 along with the current orientation information of the solar energy collector. After local control unit analyses the received data, it may determine that the solar energy collector needs to be moved by a certain distance and/or the collector surface needs to be adjusted by a certain angle in order to properly orient the solar energy collector for maximum exposure. The local control unit may calculate the offset values for these parameters and send them to the local control system unit of the solar energy collector. The local control system unit may then control the positioning mechanism of the solar energy collector to implement the offset values. In some embodiments, type of data that may be received from each solar energy collector may include but is not limited to air pressure, temperature, tracking position sensors data, temperature of a solar energy receiver, temperature of water used for cooling, flow rates, rig position, illumination of the concentrator/receiver, power output, temperature, etc. In sum, any and all data that may inform the SCADA server about the operating state of the solar energy collector may be sent by each solar energy collector. Since each solar energy collector sends its data periodically, the SCADA server can continually monitor and control each solar energy collector. Examples of commands that may be sent by the SCADA server include but are not limited to, set_target_position, get_target_position, reset_device, force_info_safe, calibrate_tracking, add_device, shutdown, etc. Server 602 may perform a one-way communication with each solar energy collector in the array to send the specific commands. For example, based on the analysis of data received from each solar energy collector, server 602 may send a command to a local control unit of a solar energy collector to calibrate the tracking sensors on the solar energy collector. The local control unit may then perform the calibration and send back the results of the calibration.

As illustrated in FIG. 6, SCADA server 602 is connected to the wireless network via wireless manager 604. The connection between the SCADA server and the wireless manager may be via a wireless connection, a wired connection, or a combination of wireless and wired connection. Wired/wireless communication useable for communication between each solar energy collector and the wireless manager and between the SCADA server and the wireless manager can include but is not limited to: Ethernet, CAN, Wi-Fi, Bluetooth, DSL, dedicated microwave links, SCADA protocols, DOE's NASPInet, SIPRNet (US Department of Defense), IEEE 802.11, IEEE 802.15.4, Frame Relay, Asynchronous Transfer Mode (ATM), IEC 14908, IEC 61780, IEC 61850, IEC 61970/61968, IEC 61334, IEC 62056, ITU-T G.hn, SONET, IPv6, SNMP, TCP/IP, UDP/IP, advanced metering infrastructure, and Smart Grid protocols. Data received in the SCADA server, can be “cached” in main memory for fast access by other systems. For example, in certain embodiments each solar energy collectors regularly sends telemetry data to the SCADA server (e.g. about every 5 seconds). Assuming there are 10,000 solar energy collectors in the field, the SCADA server will store telemetry data for all 10,000 solar energy collectors in its memory (RAM). In some embodiments, multiple SCADA servers may be used depending on the size of the solar power plant and number of solar energy collectors.

As described above, each solar energy collector periodically sends telemetry data (i.e. Churps) to the wireless manager. The sending of the telemetry data may be done automatically at specific intervals without the wireless manager querying each solar energy collector for the data. In a particular embodiment, the solar energy collector may be configured to send a 100 byte packet of telemetry data to the wireless manager about every 5 seconds. This data is cached in the memory of the SCADA server. If the data received by the SCADA server is to be accessed, a client device 610 can be coupled to the SCADA server. The client device can send a request to the SCADA server, which has the solar energy collector data ready (cached) and available. The SCADA server can then respond to the request. Since the connection between the client device and the SCADA server can be fast, data for each solar energy collector can be available to a user without any delay. In some embodiments, multiple clients can be connected to single SCADA server.

FIG. 7 is a flow diagram of a process 700 of operating a solar energy collector array according to an embodiment of the present invention.

At step 702, a control system unit in a solar energy collector can collect telemetry data and/or current operating state information about the solar energy collector. Once the data is collected, the control system unit can determine whether a predetermined time has elapsed between an immediately preceding transmission of data, at step 704. If the predetermine time has not elapsed, the control system unit waits (step 706) and checks again whether the pre-determined time has elapsed. Once it is determined that the pre-determined time has elapsed, the control system unit determines a communication path to be used for sending the data to the wireless receiver (step 708). In some embodiments, the control system unit may check the status of nearby solar energy collectors to see which of the solar energy collectors can be used to route the data. At step 710, the control system unit may select at least one neighboring second solar energy collector and dynamically open a communication channel with the first solar energy collector where none existed before. At step 712, the originating solar energy collector may send the data to the selected second solar energy collector. Once the second solar energy collector receives the data, the second solar energy collector may determine whether it is directly connected to the wireless manager, at step 714. If it is determined that the second solar energy collector is directly connected to the wireless manager, the second solar energy collector may send the data to the wireless manager at step 716.

If at step 714, it is determined that the second solar energy collector is not directly connected to the wireless manager, the process may return to step 710 where the second solar energy collector may determine another solar energy collector to forward the data to. One of the criteria used in selection of a solar energy collector to forward the data to can be that each successive solar energy collector is physically or communicatively closer to the wireless manager than the previous solar energy collector. So in this instance, the second solar energy collector is closer to the wireless manager than the originating solar energy collector. This process can continue until a solar energy collector determines that it is directly connected to the wireless manager. At that point the data is sent to the wireless manager and process 700 ends.

It should be appreciated that the specific steps illustrated in FIG. 7 provide a particular method of operating a solar energy collector array according to an embodiment of the present invention. Other sequences of steps may also be performed according to alternative embodiments. For example, alternative embodiments of the present invention may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

Having thus described exemplary embodiments of the present invention, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A method for transmitting data collected by a solar energy collector in an array of solar energy collectors wherein each solar energy collector in the array is communicatively coupled either directly or indirectly to a wireless manager unit, the method comprising:
(a) collecting telemetry data associated with the solar energy collector;
(b) determining that a predetermined time has elapsed between an immediately preceding data transmission;
(c) determining another solar energy collector in the array to forward the telemetry data, wherein the other solar energy collector is closer to the wireless manager than the solar energy collector;
(d) forwarding the telemetry data to the other solar energy collector;
(e) determining whether the other solar energy collector is in direct wireless communication with the wireless manager;
if it is determined that the other solar energy collector is in direct wireless communication with the wireless manager, sending the telemetry data to the wireless manager; and
if it is determined that the other solar energy collector is not in direct wireless communication with the wireless manager, repeating steps (c)-(e) until a solar energy collector is determined to be in direct wireless communication with the wireless manager.

2. The method of claim 1 wherein the telemetry data comprises one or more of: air pressure, temperature, flow rate, and current position of Sun in the sky.

3. The method of claim 1 wherein the predetermined time ranges between 0.5 seconds and 20 seconds.

4. The method of claim 1 further comprising, upon determining the other solar energy collector in the array to forward the telemetry data, opening a wireless communication channel with the other solar energy collector, wherein there is no preexisting communication channel between the solar energy collector and the other solar energy collector.

5. The method of claim 1 wherein the other solar energy collector is physically closer to the wireless manager than the solar energy collector.

6. The method of claim 1 further comprising:
if the other solar energy collector becomes non-operational, selecting a new solar energy collector from the array and forwarding the telemetry data to the new solar energy collector, the new solar energy collector being closer to the wireless manager than the solar energy collector.

7. A solar energy collector system comprising:
a plurality of solar energy collectors, each solar energy collector including a local control unit; and
a wireless manager unit communicatively coupled to each solar energy collector in the plurality of solar energy collectors,
wherein a first solar energy collector from the plurality of solar energy collectors is configured to:
collect telemetry and operational data associated with the first solar energy collector;
open a dynamic wireless communication channel with a second solar energy collector in the array, wherein the second solar energy collector is physically closer to the wireless manager than the solar energy collector; and
send the telemetry and operational data to the second solar energy collector;
wherein a second solar energy collector from the plurality of solar energy collectors is further configured to:
receive the telemetry and operational data from the first solar energy collector;
determine whether the second solar energy collector has a direct communication link with the wireless manager;
if the second solar energy collector has a direct communication link with the wireless manager, send the telemetry and operational data to the wireless manager; and
if the second solar energy collector does not have a direct communication link with the wireless manager, determine a third solar energy collector that is closer to the wireless manager than the second solar energy collector; and
forward the telemetry and operational data to the third solar energy collector.

8. The solar energy collector system of claim 7 wherein the first solar energy collector is further configured to, prior to opening the dynamic wireless communication channel, determine whether a predetermined time has elapsed after an immediately preceding data transmission;
if the predetermined time has elapsed, open the dynamic wireless communication channel; and
if the predetermined time has not elapsed, wait until the predetermined time has elapsed before opening the dynamic wireless communication channel.

9. The solar energy collector system of claim 8 wherein the predetermined time is between 0.5 seconds and 20 seconds.

10. The solar energy collector system of claim 7 further comprising a Supervisory Control And Data Acquisition (SCADA) server coupled to the wireless manager, the SCADA server configured to analyze the received telemetry data and send commands to one or more solar energy collectors to control the operation of the one or more solar energy collectors from the plurality of solar energy collectors.

11. A solar energy collector comprising:
a first device for capturing sunlight and focusing the captured sunlight at one or more focus points;
one or more second devices coupled to the first device and configured to convert the captured sunlight into energy;
a tracking and positioning mechanism; and
a control unit configured to control operation of the solar energy collector and wirelessly coupled to a wireless manager, wherein the control unit is configured to:
periodically send operational data of the solar energy collector to the wireless manager without the need for querying for the data by the wireless manager;
receive commands from a data acquisition server coupled to the wireless manager; and
execute the received commands.

12. The solar energy collector of claim 11 wherein the solar energy collector is part of an array of solar energy collectors communicatively coupled to each other and wherein to send operation data periodically, the control unit is further configured to:
determine a communication path between the solar energy collector and the wireless manager, the communication path including one or more solar energy collectors from the array of solar energy collectors; and
send the operational data using the determined communication path.
